(19) United States
(12) Patent Application Publication
(10) Pub. No.: US 2010/0111385 A1
(43) Pub. Date: May 6, 2010

(54) MIRROR BLOOD VESSEL AS OVERLAY ON TOTAL OCCLUSION

(75) Inventor: Erik Hummel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/594,957

(22) PCT Filed: Apr. 7, 2008
(86) PCT No.: PCT/IB08/51299

§ 371 Date: Oct. 7, 2009

(30) Foreign Application Priority Data
Apr. 11, 2007 (EP) 07105975.2

(51) Int. Cl. G06K 9/00

(52) U.S. Cl. 382/128

(57) ABSTRACT

Mirror blood vessel as overlay on total occlusion According to an exemplary embodiment of the present invention, opening of a total occlusion in a blood vessel is, in case of the availability of a mirror blood vessel, based on the overlay of the mirror vessel on the occluded blood vessel. The blood vessel may be visualised with X-ray and contrast agent.

The invention relates to the field of medical imaging. In particular, the invention relates to an examination apparatus for visualising the first blood vessel of an object of interest, a method for visualising a first blood vessel of an object of interest, a computer-readable medium, a program element and an image processing device.

With X-ray systems contrast agent can be used to visualise blood vessels. In a total occlusion contrast agent cannot enter the blocked area and therefore this part of the vessel may not be visible. These occlusions can be opened with a catheter or guide wire, just by pushing through the occlusion. The begin and end points of the occluded vessel are used for orientation.

However, opening of a total occlusion in a blood vessel may sometimes be difficult since the path of the blood vessel at the occlusion is not visible and it is not clear what the exact path of the catheter/guide wire needs to be.

It would be desirable to have an improved visualisation of blood vessels having a total occlusion.

The invention provides an examination apparatus, a computer-readable medium, a program element, an image processing device and a method for visualising a first blood vessel of an object of interest with the features according to the independent claims.

It should be noted that following described exemplary embodiments of the invention apply also for the method for visualising a first blood vessel of an object of interest, for the computer-readable medium, for the image processing device and for the program element.

According to an aspect of the present invention, an examination apparatus for visualising a first blood vessel of an object of interest is provided, the examination apparatus comprising a determination unit adapted for generating a mirror image on the basis of an original image of the object of interest and overlaying the mirror image with the original image, resulting in an overlaid image depicting the first blood vessel overlaid with a second blood vessel.

In other words, the examination apparatus is adapted for visualising a blocked or occluded blood vessel which would otherwise not be visible, because there is no contrast agent in the area of the occlusion. In order to visualise the blocked blood vessel, a mirror image is generated and overlaid with the original image. Since, for example, the occluded blood vessel has a corresponding counterpart on the other side of the body (e.g. located on the other side of the image), this counterpart can be used (after mirroring the image or even only the counterpart or single parts of the counterpart), followed by an overlaying step.

It may be in particular helpful, if the blood vessels are not only present on both sides of the body but are also more or less symmetrical to each other.

According to another exemplary embodiment of the present invention, the first blood vessel is a blood vessel with a total occlusion and the second blood vessel is a blood vessel without total occlusion.

An image of the whole vessel-tree may be acquired on the basis of a contrast agent application, which depicts the whole vessel-tree except the occluded part of the first blood vessel.

This may make possible an interventional treatment of the occluded blood vessel guided by a life sequence of the vessel-tree, in which also the occluded part of the vessel is visualised.

Even if there is a partial occlusion in the second vessel, it can still be useful as an overlay to show the course of the vessel.

According to another exemplary embodiment of the present invention, the generation of the mirror image comprises a vessel extraction from the original image performed either before or after a mirror step.

In other words, after acquisition of an original image, for example only the unblocked vessel (i.e. the vessel without occlusion which is visible in the original image) may be extracted and then mirrored, thus generating the mirror image.

Alternatively, first the mirror image is generated (from the original image) and then the vessel of interest (the blood vessel without occlusion) is extracted.

Alternatively, the whole vessel-tree or only a part of the unblocked vessel may be extracted before or after the mirror operation.

According to another exemplary embodiment of the present invention, the mirror image is generated automatically on the basis of a mirror line which is the centre line of the corresponding original image.

For example, the mirroring step is performed on the complete original image.

According to another exemplary embodiment of the present invention, the mirror image is generated manually on the basis of a mirror plane which is selected by a user.

Therefore, if the vessel-tree has an axis of symmetry which does not correspond to the centre line of the original image, this axis may be defined manually by the user.

According to another exemplary embodiment of the present invention, the definition or selection of the mirror plane or mirror line is performed on the basis of an analysis algorithm which identifies the corresponding axis of symmetry of the corresponding vessel main-direction (on which the image plane or mirror line may be perpendicular).

According to another exemplary embodiment of the present invention, the overlaying is performed on the basis of a correlation of the first and second vessels.

The correlation may be calculated by the determination unit on the basis of a corresponding registration algorithm.

According to another exemplary embodiment of the present invention, the overlaying is performed manually by translating the original image or the mirror image.

Thus, a user may manually overlay the mirrored image, or part of the mirrored image, with the original image. This may reduce computational costs.

According to another exemplary embodiment of the present invention, the overlaying is performed manually by indicating the total occlusion in the first vessel and by indicating a corresponding trajectory in the second vessel.

Alternatively, indication of the total occlusion in the first vessel may be performed automatically by the respective identification algorithm. Furthermore, indication of the corresponding trajectory in the second vessel may as well be performed by a corresponding identification algorithm.

According to another exemplary embodiment of the present invention, the examination apparatus is adapted as one of a three-dimensional computed tomography apparatus and a three-dimensional rotational X-ray apparatus.

Furthermore, according to another exemplary embodiment of the present invention, a method for visualising a first blood vessel of an object of interest is provided, the method comprising the steps of generating a mirror image on the basis of an original image of the object of interest and overlaying the mirror image with the original image, resulting in an overlaid image depicting the first blood vessel overlaid with a second blood vessel.

This may provide for an improved visualisation of blood vessels having a total occlusion.

According to another exemplary embodiment of the present invention, a computer-readable medium is provided, in which a computer program for visualising a first blood vessel of an object of interest is stored which, when being executed by a processor, causes the processor to carry out the above-mentioned method steps.

According to another exemplary embodiment of the present invention, an image processing device for visualising a first blood vessel of an object of interest is provided, the image processing device comprising a memory for storing a data set of the object of interest and a determination unit adapted for carrying out the above-mentioned method steps.

Furthermore, according to another exemplary embodiment of the present invention, a program element for visualising a first blood vessel of an object of interest is provided, which, when being executed by a processor, causes the processor to carry out the above-mentioned method steps.

Those skilled in the art will readily appreciate that the method may be embodied as the computer program, i.e. by software, or may be embodied using one or more special electronic optimization circuits, i.e. in hardware, or the method may be embodied in hybrid form, i.e. by means of software components and hardware components.

The program element according to an exemplary embodiment of the invention may preferably be loaded into working memories of a data processor. The data processor may thus be equipped to carry out embodiments of the methods of the present invention. The computer program may be written in any suitable programming language, such as, for example, C++ and may be stored on a computer-readable medium, such as a CD-ROM. Also, the computer program may be available from a network, such as the WorldWideWeb, from which it may be downloaded into image processing units or processors, or any suitable computers.

It may be seen as the gist of an exemplary embodiment of the present invention that, in case one of the imaged vessels has a total occlusion, the user may use the trajectory of the other mirrored vessel to guide the catheter/guide wire at the total occlusion. Therefore, the mirrored blood vessel is overlaid on the blood vessel with the total occlusion. In the first step, the blood vessels (with contrast agent) are extracted from the image on the basis of an extraction algorithm. In the second step, the correlation between the left and right side blood vessels is determined. In a third step, the blood vessel with the total occlusion is overlaid with the mirror blood vessel.

These and other aspects of the present invention will become apparent from and elucidated with reference to the embodiments described hereinafter.

Exemplary embodiments of the present invention will now be described with reference to following drawings:

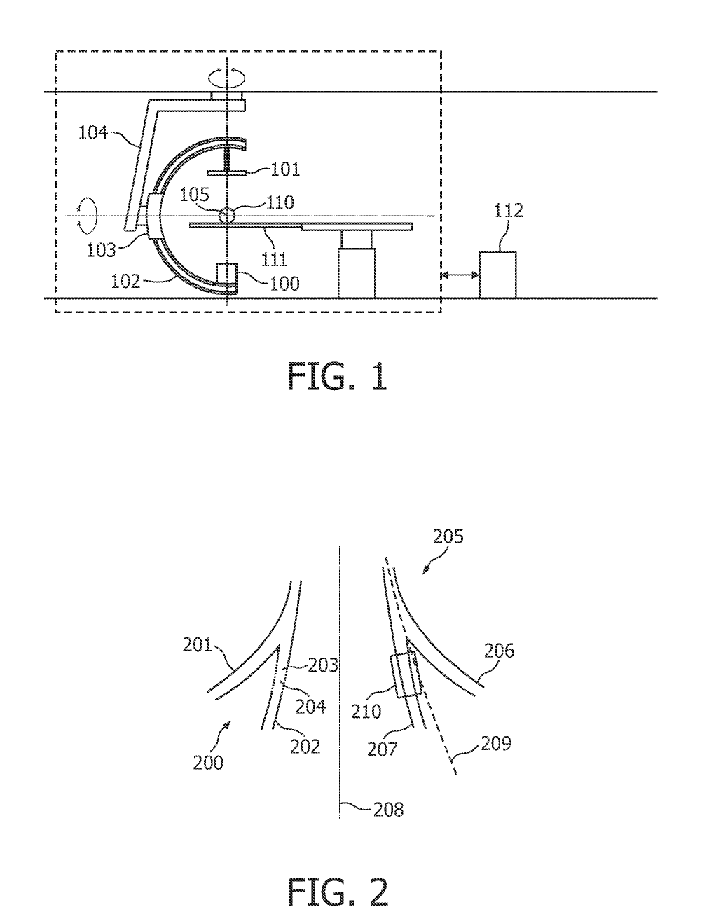

FIG. 1 shows a schematic representation of a rotational X-ray scanner according to an exemplary embodiment of the present invention.

FIG. 2 shows a schematic representation of a vessel-tree visualised by a method according to an exemplary embodiment of the present invention.

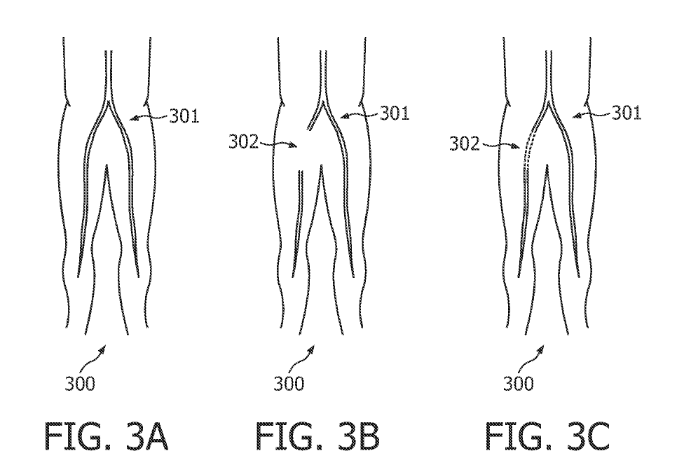

FIG. 3A shows an image of a patient with a normal iliac.

FIG. 3B shows an image of a patient with a total occlusion.

FIG. 3C shows an image of the patient of FIG. 3B after the overlay.

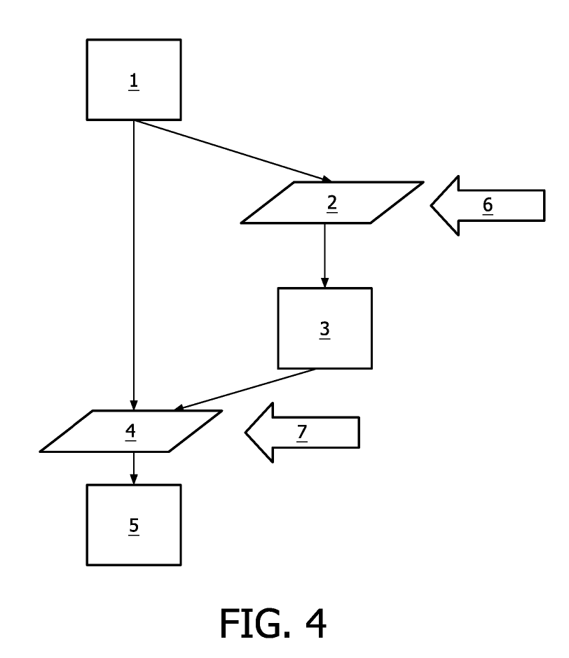

FIG. 4 shows a flow-chart of a method according to an exemplary embodiment of the present invention.

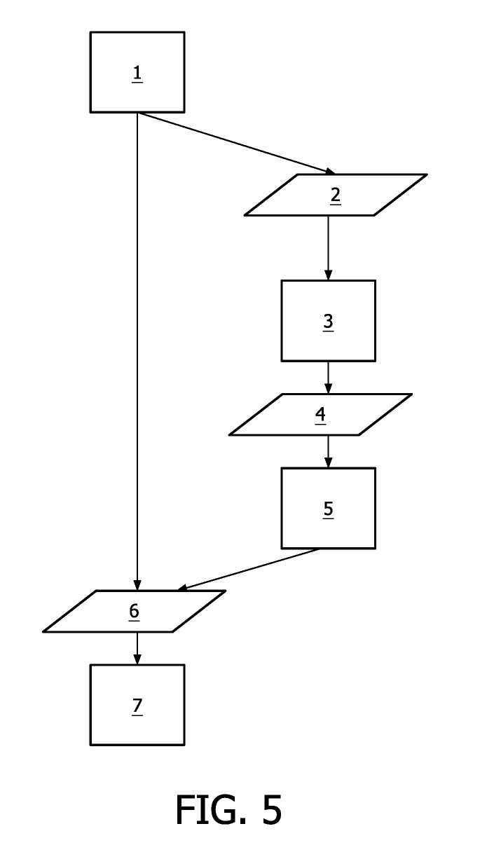

FIG. 5 shows a flow-chart of a method according to another exemplary embodiment of the present invention.

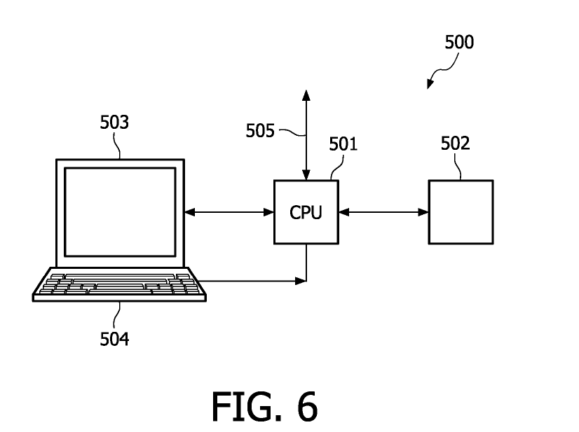

FIG. 6 shows an exemplary embodiment of an image processing device according to the present invention, for executing an exemplary embodiment of a method in accordance with the present invention.

The illustration in the drawings is schematically. In different drawings, similar or identical elements are provided with the same reference numerals.

FIG. 1 shows a schematic representation of an exemplary rotational X-ray scanner in which a method according to the invention may be implemented.

It should be noted, however, that the present invention is not limited to C-arm X-ray scanners, but that the examination apparatus may also be adapted as a computed tomography apparatus (CT), a coherent scatter computed tomography apparatus (CSCT), a positron emission tomography apparatus (PET), a single photon emission computed tomography apparatus (SPECT), a magnetic resonance scanner (MR) or an ultrasound scanner. Also an image from one type of examination apparatus (for instance CT) may be used to generate the mirrored overlay to be used on another type of apparatus (for instance X-ray).

As depicted in FIG. 1, an X-ray source 100 and a flat detector 101 with a large sensitive area are mounted to the ends of a C-arm 102. The C-arm 102 is held by curved rail, the “sleeve” 103. The C-arm can slide in the sleeve 103, thereby performing a “roll movement” about the axis of the C-arm. The sleeve 103 is attached to an L-arm 104 via a rotational joint and can perform a “propeller movement” about the axis of this joint. The L-arm 104 is attached to the ceiling via another rotational joint and can perform a rotation about the axis of this joint. The various rotational movements are effected by servo motors. The axes of the three rotational movements and the cone-beam axis always meet in a single fixed point, the “isocenter” 105 of the rotational X-ray scanner. There is a certain volume around the isocenter that is projected by all cone beams along the source trajectory. The shape and size of this “volume of projection” (VOP) depend on the shape and size of the detector and on the source trajectory. In FIG. 1, the ball 110 indicates the biggest isocentric ball that fits into the VOP. The object (e.g. a patient or an item of baggage) to be imaged is placed on the table 111 such that the object's VOI fills the VOP. If the object is small enough, it will fit completely into the VOP; otherwise, not. The VOP therefore limits the size of the VOI.

The various rotational movements are controlled by a control unit 112 which may also be used as a determination unit for processing measured data. Each triple of C-arm angle, sleeve angle, and L-arm angle defines a position of the X-ray source. By varying these angles with time, the source can be made to move along a prescribed source trajectory. The detector at the other end of the C-arm makes a corresponding movement.

FIG. 2 shows a schematic representation of a vessel-tree which is depicted according to a method of the present invention. The vessel-tree 200 is for example located in a leg or an arm of a patient. The vessel-tree 200 comprises two vessel arms 201, 202. The second vessel arm 202 comprises a total occlusion 203. Therefore, the section 204 of the second vessel arm 202 is not depicted in the angiography image, since no contrast agent is able to enter this part of the vessel 200.

However, on the other side of the body, i.e. the other leg or the other arm, a corresponding vessel-tree 205 is located, which is more or less symmetrical to the first vessel-tree 200. Since the whole second vessel-tree 205 can be visualised (because it does not contain a total occlusion), it can be used for visualising the occluded vessel part 204.

For example, the whole image can be mirrored at the central line 208. Alternatively, only the second vessel-tree 205 can be mirrored, after extraction of the second vessel-tree 205.

Another possibility is to define an individual mirror plane or mirror line 209, which corresponds to a main direction of the second vessel tree 205.

After mirroring of the second vessel-tree 205 (or after mirroring of the interesting part of the second vessel, i.e. section 210) a registration or overlay is performed, such that the part 204 of the first vessel-tree is now visualised by the mirrored part 210.

FIG. 3A shows an image of a patient 300 with a normal iliac artery 301.

FIG. 3B shows an image of a patient 300 with a total occlusion in a certain part 302 of the vessel located in the right leg. The occluded part 302 cannot be seen because it does not contain contrast agent.

FIG. 3C shows an image of the patient of FIG. 3B after the overlay. As it can be seen from FIG. 3C, the occluded part 302 of the vessel is now visualized.

FIG. 4 shows a flow-chart of an exemplary embodiment of a method according to the present invention. The overlay of the blood vessel on the blood vessel with the total occlusion can be a manual or fully automatic procedure, or some mix of a manual or automatic procedure. For the manual procedure, which is depicted in FIG. 3, the first step comprises an acquisition of an original image.

Then, in a second step, a mirror image is generated. The user can do this by indicating a mirror plane. Another option is to generate the mirror image automatically by using a mirror line, i.e. the centre line of the image. This results in an image of step 3.

Then, in step 4, which is an overlay step, the user can manually overlay the two images by translating one of the two images. Alternatively, the user indicates, for example by mouse points, the total occlusion and indicates in a further step the same trajectory on the other mirror blood vessel.

This results in an overlaid image in step 5.

Steps 2 and 4 may require user input 6, 7, respectively.

The invention may be used for both two-dimensional and three-dimensional images.

FIG. 5 shows a flow-chart of a method according to another exemplary embodiment of the present invention, depicting a fully automatic procedure. In the first step, the original image is acquired. Then, in step 2, the vessels are extracted from the X-ray image resulting in an extracted vessel image in step 3.

This step is followed by a mirror operation in step 4.

It should be noted that the mirror operation and the vessel extraction operation may be interchanged, i.e. the vessel extraction may be performed before or after the mirror operation of step 4.

In any case, the product of the combined mirror and vessel extraction operations is a mirrored extracted vessel image in step 5. The mirror plane (or line) depends on the directions of the vessels. For example, the mirror plane is perpendicular the vessel directions.

In step 6, the two images are correlated, such that the best overlay can be made, resulting in an overlaid image in step 7. This correlation may also help if the two vessels are not completely symmetrical.

In case of an incomplete symmetry of the two vessels, special registration steps may be performed for registering or overlaying the interesting parts of the vessels. The registration may be performed fully automatic.

The invention may be used in interventional techniques, i.e. vascular or neuro, where both left and right side blood vessels are visible using an X-ray system and contrast agent or any other imaging modality. It may also be used during a diagnostic phase to support a decision on the optimal therapeutic treatment during an optional subsequent interventional phase.

FIG. 6 shows an exemplary embodiment of a data processing device 500 according to the present invention for executing an exemplary embodiment of a method in accordance with the present invention.

The data processing device 500 depicted in FIG. 5 comprises a central processing unit (CPU) or image processor 501 connected to a memory 502 for storing an image depicting an object of interest, such as the heart of a patient or an item of baggage. The central processing unit 501 may comprise a determination unit (not depicted in FIG. 5) according to an aspect of the present invention.

The image processor 501 may be connected to a plurality of input/output network or diagnosis devices, such as a computer tomography scanner. The image processor 501 may furthermore be connected to a display device 503, for example, a computer monitor, for displaying information or an image computed or adapted in the image processor 501. An operator or user may interact with the image processor 501 via a keyboard 504 and/or other input or output devices, which are not depicted in FIG. 5.

Furthermore, via the bus system 505, it may also be possible to connect the image processing and control processor 501 to, for example, a motion monitor, which monitors a motion of the object of interest. In case, for example, a lung of a patient is imaged, the motion sensor may be an exhalation sensor. In case the heart is imaged, the motion sensor may be an electrocardiogram.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims:

1. Examination apparatus for visualising a first blood vessel of an object of interest the examination apparatus (100) comprising a determination unit (112) adapted for:
generating a mirror image on the basis of an original image of the object of interest; and
overlaying the original image with the mirror image, resulting in an overlaid image depicting the first blood vessel overlaid with a second blood vessel.

2. Examination apparatus of claim 1,
wherein the first blood vessel is a blood vessel with a total occlusion; and
wherein the second blood vessel is a blood vessel without total occlusion.

3. Examination apparatus of claim 1,
wherein generation of the mirror image comprises a vessel extraction from the original image performed one of before or after a mirror step.

4. Examination apparatus of claim 1,
wherein the mirror image is generated automatically on the basis of a mirror line which is the centre line of the corresponding original image.

5. Examination apparatus of claim 1,
wherein the mirror image is generated manually on the basis of a mirror plane which is selected by a user.

6. Examination apparatus of claim 1,
wherein the overlaying is performed on the basis of a correlation of the first and second vessels.

7. Examination apparatus of claim 1,
wherein the overlaying is performed manually by translating one of the original image or the mirror image.

8. Examination apparatus of claim 1,
wherein the overlaying is performed manually by indicating the total occlusion in the first vessel and by indicating a corresponding trajectory in the second vessel.

9. Examination apparatus of claim 1, the examination apparatus (100) being adapted as one of a C-arm X-ray scanner, a computed tomography apparatus, a coherent scatter computed tomography apparatus, a positron emission tomography apparatus, a single photon emission computed tomography apparatus, a magnetic resonance scanner, an ultrasound scanner.

10. A method for visualising a first blood vessel of an object of interest (107), the method comprising the steps of:
generating a mirror image on the basis of an original image of the object of interest; and
overlaying the mirror image with the original image, resulting in an overlaid image depicting the first blood vessel overlaid with a second blood vessel.

11. Method of claim 10,
wherein the second blood vessel has been generated on another imaging apparatus than the first blood vessel.

12. A computer-readable medium (502), in which a computer program for visualising a first blood vessel of an object of interest is stored which, when executed by a processor (501), causes the processor to carry out the steps of:
generating a mirror image on the basis of an original image of the object of interest; and
overlaying the mirror image with the original image, resulting in an overlaid image depicting the first blood vessel overlaid with a second blood vessel.

13. A program element for visualising a first blood vessel of an object of interest, which, when being executed by a processor (501), causes the processor to carry out the steps of:
generating a mirror image on the basis of an original image of the object of interest; and
overlaying the mirror image with the original image, resulting in an overlaid image depicting the first blood vessel overlaid with a second blood vessel.

14. An image processing device for visualising a first blood vessel of an object of interest, the image processing device comprising:
a memory for storing an original image of the object of interest; and
a determination unit adapted for:
generating a mirror image on the basis of an original image of the object of interest; and
overlaying the mirror image with the original image, resulting in an overlaid image depicting the first blood vessel overlaid with a second blood vessel.
